(19) United States
(12) Patent Application Publication
(10) Pub. No.: US 2007/0179850 A1
(43) Pub. Date: Aug. 2, 2007

(54) Method, system, and computer program product for rewarding customer loyalty

(75) Inventors: Robert F. Ganjon, South Orange, NJ (US); Gregg M. Hirano, Secaucus, NJ (US); Nancy E. Hood, Brooklyn, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/439,536

(22) Filed: May 24, 2006

Related U.S. Application Data
(60) Provisional application No. 60/683,808, filed on May 24, 2005.
(60) Provisional application No. 60/728,323, filed on Oct. 20, 2005.

(51) Int. Cl. G06Q 30/00

(52) U.S. Cl. 705/14

(57) ABSTRACT

A service-related merchant may link its rewards program to a transaction account held by a consumer. Points may be awarded to the transaction account at an accelerated earning rate for various types of spend by the consumer, such as every day spend and direct spend. Additionally, points earned through any use of the transactional card are deposited directly into the rewards program offered by the service provider, rather than a generic rewards program offered by the transactional card company. Accumulated points in the rewards program may then be used directly in exchange for goods and services provided by the merchant. Such exchange occurs directly between the customer and the service provider. VIP status in the service provider's reward program may be earned solely on the basis of spend using the transactional card, and does not require a minimum amount of direct spend with the service provider.

### CROSS-REFERENCE TO RELATED APPLICATIONS

The present application claims the benefit of U.S. Provisional Patent Application No. 60/683,808, filed May 24, 2005, and U.S. Provisional Patent Application No. 60/728,323, filed Oct. 20, 2005, each of which is incorporated by reference herein in its entirety.

### BACKGROUND OF THE INVENTION

1. Field of the Invention

The present invention relates to loyalty rewards programs, specifically loyalty rewards programs associated with a financial transaction account.

2. Related Art

Point-based rewards programs have been used to encourage spending on a given card by a user. However, loyalty to both a particular transaction card company and a service provider has not adequately been rewarded by existing systems. Further, existing systems do not allow customers flexibility on earning points and/or membership status. Points and/or preferred membership status in the service provider's rewards program are rewarded only for direct spending with the given service provider. Additionally, points earned through spending by the customer are typically placed in a generic rewards account provided by the transaction card company. Redemption of the points then requires interaction with the transaction card company as an intermediary between the customer and the service provider. What is needed is a system and method for increasing customer loyalty while also increasing the flexibility of the customer to earn points and/or preferred membership status.

### BRIEF SUMMARY OF THE INVENTION

A reward point account associated with a service provider's rewards program may be linked to a transaction account held by a customer with a transaction account company. Points may be awarded to the reward point account at an accelerated earning rate for various types of spending by the customer, such as every day spend and direct spend. Additionally, points earned through use of the transaction account for any type of spending are deposited directly into the reward point account associated with the service provider, rather than a generic reward point account associated with the transaction account company. Accumulated points in the rewards program may then be used in exchange for goods and services provided by the service provider without further involvement from the transaction company. Once the customer has spent a certain monetary amount using the transaction account, the customer may be awarded preferred membership status in the service provider's rewards program. The preferred membership status is awarded regardless of whether the spending is direct spend or non-direct spend, and does not require a minimum amount of direct spend with the service provider.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart of an exemplary method for rewarding customer loyalty.

FIG. 2 is a block diagram of an exemplary computer system useful for implementing the present invention.

The present invention will be described with reference to the accompanying drawings. The drawing in which an element first appears is typically indicated by the leftmost digit(s) in the corresponding reference number.

### DESCRIPTION OF THE INVENTION

I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” and/or the plural form of these terms are used interchangeably throughout herein to refer to those persons or entities capable of accessing, using, being affected by and/or benefiting from the tool that the present invention provides for the rewards program described herein. This includes both individual consumers and corporate customers such as, for example, small businesses.

Furthermore, the terms “service provider,” “business,” or “merchant” may be used interchangeably with each other and shall mean any person, entity, distributor system, software and/or hardware that is a provider, broker and/or any other entity in the distribution chain of goods or services. For example, a service provider may be a hotel company, an airline company, a travel agency, an on-line merchant or the like.

1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

2. Open Versus Closed Cards

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

3. Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars.

4. Use of Transaction Accounts

With regard to use of a transaction account, users may communicate with service providers in person (e.g., at the box office), telephonically, or electronically (e.g., from a user computer via the Internet). During the interaction, the service provider may offer goods and/or services to the user. The service provider may also offer the user the option of paying for the goods and/or services using any number of available transaction accounts. Furthermore, the transaction accounts may be used by the service provider as a form of identification of the user. The service provider may have a computing unit implemented in the form of a computer-server, although other implementations are possible.

In general, transaction accounts may be used for transactions between the user and service provider through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

5. Account and Merchant Numbers

An “account,” “account number,” or “account code,” as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

A merchant account number may be, for example, any number or alpha-numeric characters that identifies a particular merchant for purposes of card acceptance, account reconciliation, reporting and the like.

6. RFID and Transmission of Magnetic Stripe Data

It should be noted that the transfer of information in accordance with the present invention may be done in a format recognizable by a merchant system or account issuer. In that regard, by way of example, the information may be transmitted from an RFID device to an RFID reader, or from the RFID reader to the merchant system in magnetic stripe or multi-track magnetic stripe format.

Because of the proliferation of devices using magnetic stripe format, the standards for coding information in magnetic stripe format were standardized by the International Organization for Standardization in ISO/IEC 7811-n (characteristics for identification cards) which are incorporated herein by reference. The ISO/IEC 7811 standards specify the conditions for conformance, physical characteristics for the card (warpage and surface distortions) and the magnetic stripe area (location, height and surface profile, roughness, adhesion, wear and resistance to chemicals), the signal amplitude performance characteristics of the magnetic stripe, the encoding specification including technique (MFM), angle of recording, bit density, flux transition spacing variation and signal amplitude, the data structure including track format, use of error correction techniques, user data capacity for ID-1, ID-2 and ID-3 size cards, and decoding techniques, and the location of encoded tracks.

Typically, magnetic stripe information is formatted in three tracks. Certain industry information must be maintained on certain portions of the tracks, while other portions of the tracks may have open data fields. The contents of each track and the formatting of the information provided to each track is controlled by the ISO/IEC 7811 standard. For example, the information must typically be encoded in binary. Track 1 is usually encoded with user information (i.e., name) in alphanumeric format. Track 2 is typically comprised of discretionary and nondiscretionary data fields. In one example, the nondiscretionary field may comprise 19 characters and the discretionary field may comprise 13 characters. Track 3 is typically reserved for financial transactions and includes enciphered versions of the user's personal identification number, country code, current units amount authorized per cycle, subsidiary accounts, and restrictions.

As such, where information is provided in accordance with the present invention, it may be provided in magnetic stripe track format. For example, the counter values, authentication tags and encrypted identifiers may be forwarded encoded in all or a portion of a data stream representing data encoded in, for example, track 2 or track 3 format.

Persons skilled in the relevant arts will understand the breadth of the terms used herein and that the exemplary descriptions provided are not intended to be limiting of the generally understood meanings attributed to the foregoing terms. It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

II. Rewards Program

A transaction account company, such as American Express Travel Related Services Co., Inc., of New York, N.Y, can collaborate with a service provider to produce a rewards or incentive program. This product can be made possible by the service provider's investment in the product. For example, the service provider may be a hotel company, such as Hilton Hotels Corp. of Beverly Hills, Calif.

In an example collaboration, a service provider's point-value rewards program may be linked with a customer's transaction account managed by the transaction account company, such that the customer gains points in the rewards program based on the customer's frequent use of the transaction account. The points may accumulate in a reward point account linked to the customer's transaction account and associated with the service provider's rewards program. After a number of points have accumulated in the customer's reward point account, the customer can redeem the points for exchange with the related service provider. Although the present invention will be described herein with reference to a hotel company, one of skill in the pertinent art(s) will recognize that a similar program can be implemented with other types of service providers without departing from the spirit and scope of the present invention. Further, although the present invention will be described with reference to specific categories and point values, one of skill in the pertinent art(s) will recognize that other categories and point values may be used without departing from the spirit and scope of the present invention.

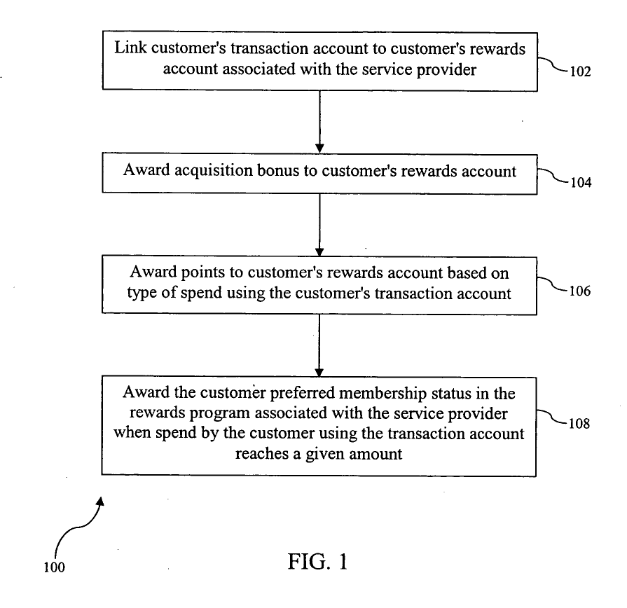

FIG. 1 is a flowchart of an exemplary method 100 of rewarding customer loyalty. In step 102, the customer's transaction account associated with the transaction account company is linked to the customer's reward point account associated with the service provider's rewards program. The customer's reward point account may be opened at the same time the customer's transaction account is opened, or the reward point account may be opened at the time of linking to an existing transaction account. Alternatively, the customer's transaction account may be linked with an existing reward point account.

After the rewards point account has been linked with the transaction account, method 100 proceeds to step 104. In step 104, an acquisition bonus, such as a 20,000 point acquisition bonus, is awarded based on the customer's first post-linking uses of the transaction account. This point acquisition bonus may be granted all at once based on any type of spending, or may be divided into generic spending and spending related to the service provider. For example, in the 20,000 point acquisition bonus system, the customer may be rewarded 10,000 points from his first purchase. Additionally, if the service provider is a hotel, for example, the customer may be rewarded 2,500 points for each of the customer's first four stays at the related hotel, up to 10,000 points.

After the initial point acquisition bonus, the customer may be rewarded additional points for various types of spending in step 106 of method 100.

General spending by a customer is typically given a base earning rate by the rewards program. This type of spending is typically referred to as “general spend.” For example, every dollar spent by the customer for general spending using the related transaction account may earn three points in the service provider's reward program.

Another type of spending is “every day spend” (“EDS”). EDS includes, e.g., spend at restaurants, supermarkets, gas stations, drug stores, postal service providers, and wireless telephone companies. EDS may earn customers points in the rewards program at an accelerated rate. For EDS, for example, a customer may be awarded five points in the service provider's rewards program for every dollar spent.

Another type of spending is called “direct spend.” Direct spend includes spending for goods and services provided by the related service provider. For example, if the service provider is a hotel company, every dollar spent at a hotel within the company is classified as direct spend. Any spending for goods and services not related to the service provider, such as, for example, general spend or EDS, will be referred to herein as “non-direct spend.” Direct spend also may earn customers points in the service provider's rewards program at an accelerated rate. For example, the customer may be awarded five points in the service provider's rewards program for every dollar spent in direct spend.

Another type of spending is related to booking services provided by the service provider online. If the service provider is a hotel company, for example, a customer may be rewarded for making one or more reservations at the hotel online using the transaction account linked to the reward point account, and for using the same transaction account to ultimately pay for the reservation. Alternatively, the customer may receive rewards for reserving the hotel room with any transaction card and then paying for the reservation using the transaction account linked to the reward point account. This online spending reward may be available for any type of online booking, or it may be available only if the customer books the reservation through a website specifically associated with the hotel. Spending through online reservations with the service provider may earn customers points in the rewards program at an accelerated rate. For example, if the service provider is a hotel, the customer may be rewarded 500 points as a bonus for making a reservation with the hotel online.

Once points have been awarded to the customer's reward point account, method 100 may proceed to optional step 108. In addition to the points offered for various spending categories in step 106, different levels of membership (also referred to as membership status) in the related rewards program may also be provided to the customer. Whereas most members of the rewards program have a base membership status in the rewards program, certain customers of the rewards program may have an elite or preferred membership status. A customer having preferred status in a rewards program typically has access to additional benefits and services that are not available to customers having only base membership status.

Previously, preferred status in a service provider's rewards program could be earned only through spending a specified amount in direct spend with that service provider. For example, preferred status has typically been earned based on the number of stays or nights in a given period of time, such as a year. In an embodiment of the present invention, however, preferred status in the service provider's rewards program may be earned through a combination of direct and non-direct spend using the transactional account linked to the rewards program, not just for direct spend with the service provider. If multiple tiers of preferred status are available for the rewards program, a customer having a transaction account linked with the rewards program may automatically be awarded with a lower-tier preferred membership status, while a higher-tier preferred membership status may be awarded to the customer when the customer reaches a certain level of spend on the linked transaction account. This award of preferred membership status occurs at step 108 of method 100.

For example, one membership level, such as a base membership level, may be available to all customers of the service provider's rewards program for the duration of their membership. A customer whose transaction account is linked with the service provider's rewards program may automatically be awarded a lower-tier preferred membership status that offers greater benefits than the base membership level. If the customer spends a certain monetary amount in either direct spend or non-direct spend using the transaction account linked to the rewards program during a given time interval, the customer may then be elevated to a higher-tier preferred membership level in the rewards program. The higher-tier preferred membership level offers greater benefits than the lower-tier preferred membership level. As an example, once the customer spends, e.g., $20,000 in a year using a transaction account linked to the customer's reward point account, the customer may be awarded higher-tier preferred membership status in the rewards program.

Customers having a transaction account linked to the service provider's rewards program may also be offered additional benefits that are unavailable to customers who are not members of the rewards program or who do not have a transaction account linked to the rewards program. For example, exclusive discount redemption rates may be available to customers having a transaction account linked to the service provider's rewards program. With an exclusive discount redemption rate, the customer may redeem points for a given good or service at a lower redemption rate than a rewards program member who does not have a transaction account linked with the rewards program.

Using the example of a hotel company, the hotel company may have multiple categories of hotels, each category corresponding to a different point value needed to redeem a stay at a hotel in the category. A Category 1 hotel may require redemption of a relatively low number of points per night, while a Category 6 hotel may require redemption of a relatively high number of points per night. Members of the hotel rewards program having a transaction account linked to the rewards program may be given better redemption rates for certain hotel categories than members of the hotel rewards program who do not have a transaction account linked to the rewards program. For example, a four-night stay at a Category 5 hotel may require 140,000 points from members of the rewards program who do not have a linked transaction account, while a four-night stay at a Category 6 hotel may require 160,000 points from members of the rewards program who do not have a linked transaction account. Meanwhile, members of the rewards program who do have a transaction account linked to the rewards program may redeem a four-night stay at a Category 5 or Category 6 hotel for only 125,000 points.

A new transaction instrument, such as a card, may be issued to the customer for the transaction account linked to the service provider rewards program, or the customer may continue using an existing transaction instrument associated with the transaction account linked to the rewards program. The transaction instrument may contain an RFID component (e.g., RFID tag) allowing for RFID functionality. The RFID component may store the service provider rewards program number associated with the customer's reward point account. The RFID component may also store customer information to facilitate use of the transaction instrument with the service provider. For example, if the service provider is a hotel, the RFID component may store customer information to facilitate the check-in/check-out process of the hotel. Further, the RFID component may store security codes, providing the transaction instrument with additional functionality as a room key or access pass. Such additional functionality allows the customer to enter certain hotel facilities (e.g., health club, guest room) without a separate access card.

After a number of points have built up in the customer's reward point account, the customer may redeem the points in exchange for goods and/or services provided by the service provider. To redeem the points, the customer may request the exchange of reward points directly from the associated service provider without using a transaction account company as an intermediary. If the exchange is being completed over the Internet, for example, the customer may use a customer computer to request an exchange of rewards points for the available goods and/or services from a server computer associated with the rewarding merchant. The customer's reward point account is then decreased by the requested number of reward points and the customer is provided with the requested good and/or service.

III. EXAMPLE IMPLEMENTATIONS

The present invention or any part(s) or function(s) thereof may be implemented using hardware, software or a combination thereof and may be implemented in one or more computer systems or other processing systems. However, the manipulations performed by the present invention were often referred to in terms, such as exchanging or selecting, which are commonly associated with mental operations performed by a human operator. No such capability of a human operator is necessary, or desirable in most cases, in any of the operations described herein which form part of the present invention. Rather, the operations may be machine operations. Useful machines for performing the operation of the present invention include general purpose digital computers or similar devices.

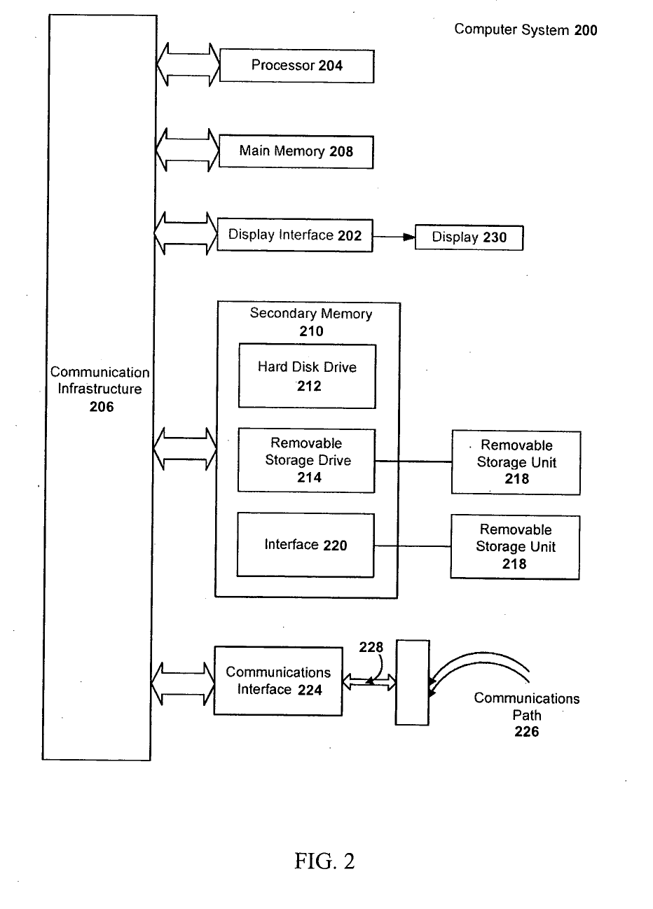

In fact, in one embodiment, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 218 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 218 and interfaces 220, which allow software and data to be transferred from the removable storage unit 218 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 214 and a hard disk installed in hard disk drive 212. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

IV. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of rewarding spend by a customer using a transaction account, comprising:
linking the transaction account to a reward point account associated with a service provider rewards program;
awarding points to the reward point account at a base earning rate for spend using the transaction account; and
awarding a preferred membership status in the service provider rewards program based on a combination of direct and non-direct spend by the customer using the transaction account.

2. The method of claim 1, wherein the second awarding step comprises:
awarding a lower-tier preferred membership status in the service provider rewards program when the transaction account is linked to the reward point account; and
awarding a higher-tier preferred membership status in the service provider rewards program when the combination of direct and non-direct spend reaches a given level.

3. The method of claim 1, further comprising:
awarding points to the reward point account at an accelerated earning rate for direct spend with the service provider using the transaction account.

4. The method of claim 1, further comprising:
redeeming a service requested by the customer at an exclusive discount redemption rate.

5. The method of claim 1, further comprising:
awarding an acquisition bonus to the reward point account, wherein reward points in the bonus are determined based on an initial direct or non-direct spend purchase.

6. The method of claim 5, further comprising:
awarding an additional acquisition bonus to the reward point account, wherein reward points in the additional acquisition bonus are determined based on a number of direct spend purchases.

7. The method of claim 1, further comprising:
awarding points to the reward point account at an accelerated earning rate for every day spend by the customer using the transaction account.

8. The method of claim 1, further comprising:
allowing access to service provider facilities using radio frequency identification (RFID) functionality included in a transaction instrument associated with the transaction account.

9. The method of claim 8, wherein the service provider is a hotel company, and the step of allowing access comprises allowing use of the transaction instrument as a door key.

10. The method of claim 1, wherein the service provider is a hotel company.

11. A system for rewarding spend by a customer using a transaction account, comprising:
a processor; and
a memory in communication with the processor, the memory for storing a plurality of processing instructions for directing the processor to:
link the transaction account to a reward point account associated with a service provider rewards program;
award points to the reward point account at a base earning rate for spend using the transaction account; and
award a preferred membership status in the service provider rewards program based on a combination of direct and non-direct spend by the customer using the transaction account.

12. The system of claim 11, wherein the plurality of processing instructions for directing the processor to award a preferred membership status comprises instructions for directing the processor to:
award a lower-tier preferred membership status in the service provider rewards program when the transaction account is linked to the reward point account; and
award a higher-tier preferred membership status in the service provider rewards program when the combination of direct and non-direct spend reaches a given level.

13. The system of claim 11, wherein the plurality of processing instructions further comprises instructions for directing the processor to:
award points to the reward point account at an accelerated earning rate for direct spend with the service provider using the transaction account.

14. The system of claim 11, wherein the plurality of processing instructions further comprises instructions for directing the processor to:
redeem a service requested by the customer at an exclusive discount redemption rate.

15. The system of claim 11, wherein the plurality of processing instructions further comprises instructions for directing the processor to:
award an acquisition bonus to the reward point account, wherein reward points in the bonus are determined based on an initial direct or non-direct spend purchase.

16. The system of claim 15, wherein the plurality of processing instructions further comprises instructions for directing the processor to:
award an additional acquisition bonus to the reward point account, wherein reward points in the additional acquisition bonus are determined based on a number of direct spend purchases.

17. The system of claim 11, wherein the plurality of processing instructions further comprises instructions for directing the processor to:
award points to the reward point account at an accelerated earning rate for every day spend by the customer using the transaction account.

18. The system of claim 11, wherein the plurality of processing instructions further comprises instructions for directing the processor to:
allow access to service provider facilities using radio frequency identification (RFID) functionality included in a transaction instrument associated with the transaction account.

19. The system of claim 18, wherein the service provider is a hotel company, and the instructions for directing the processor to allow access comprise instructions for directing the processor to allow use of the transaction instrument as a door key.

20. The system of claim 11, wherein the service provider is a hotel company.

21. A computer program product comprising a computer usable medium having control logic stored therein for causing a computer to reward spend by a customer using a transaction account, said control logic comprising:
first computer readable program code means for causing the computer to link the transaction account to a reward point account associated with a service provider rewards program;
second computer readable program code means for causing the computer to award points to the reward point account at a base earning rate for spend using the transaction account; and
third computer readable program code means for causing the computer to award a preferred membership status in the service provider rewards program based on a combination of direct and non-direct spend by the customer using the transaction account.

22. The computer program product of claim 21, wherein the third computer readable program code means comprises:
fourth computer readable program code means for causing the computer to award a lower-tier preferred membership status in the service provider rewards program when the transaction account is linked to the reward point account; and
fifth computer readable program code means for causing the computer to award a higher-tier preferred membership status in the service provider rewards program when the combination of direct and non-direct spend reaches a given level.

23. The computer program product of claim 21, further comprising:
fourth computer readable program code means for causing the computer to redeem a service requested by the customer at an exclusive discount redemption rate.

24. The computer program product of claim 21, further comprising:
fourth computer readable program code means for causing the computer to award an acquisition bonus to the reward point account, wherein reward points in the bonus are determined based on an initial direct or non-direct spend purchase.

25. The computer program product of claim 24, further comprising:
fifth computer readable program code means for causing the computer to award an additional acquisition bonus to the reward point account, wherein reward points in the additional acquisition bonus are determined based on a number of direct spend purchases.

26. The computer program product of claim 21, further comprising:
fourth computer readable program code means for causing the computer to allow access to service provider facilities using radio frequency identification (RFID) functionality included in a transaction instrument associated with the transaction account.
